(19) United States
(12) Patent Application Publication
(10) Pub. No.: US 2021/0339132 A1
(43) Pub. Date: Nov. 4, 2021

(54) Method and System for Visual Display of Audio Cues in Video Games

(71) Applicant: Steven Shakespeare, Arlington, VA (US)

(72) Inventor: Steven Shakespeare, Arlington, VA (US)

(21) Appl. No.: 17/302,137

(22) Filed: Apr. 25, 2021

Related U.S. Application Data
(60) Provisional application No. 63/016,065, filed on Apr. 27, 2020.

(51) Int. Cl. A63F 13/424; H04S 1/00; G10L 21/10; G10L 25/57; G09G 3/32; G09G 3/20; A63F 13/215; A63F 13/537

(52) U.S. Cl. CPC A63F 13/424; H04S 1/007; G10L 21/10; G10L 25/57; G10L 2021/065; G09G 3/2003; A63F 13/215; A63F 13/537; G09G 3/32

(57) ABSTRACT

Methods and systems are provided that provide visual display of audio signals in a video game. In one implementation, the system provides video game audio cues to deaf and hard of hearing players with audio cue reactive light emitting diode (LED) displays. These may be in the form of two lighting components placed on either side of a visual display. Audio cue reactive LED displays increase audio accessibility by converting audio stimuli into visual stimuli. Audio cue reactive LED displays can be attached to the left side and right side of any video game display, for example, to provide consistent sensory feedback that does not have to be in constant physical contact with deaf and hard of hearing players.

### FIELD OF THE INVENTION

The present disclosure generally relates to the field of audio processing, particularly to displaying visual cues associated with audio content in video games.

### BACKGROUND

Modern computing technologies have brought in a new era of immersive experiences in video gaming, where immersion enhances the gaming or spectating experience by making it more realistic, engaging, and interactive, with images, sounds, and haptic feedbacks that simulate the user's presence.

However, deaf and hard of hearing individuals are unable to effectively perceive video game sound stimulus such as footsteps, approaching enemies, gunshots, explosions or other sound effects. Audio accessibility limitations create barriers for deaf and hard of hearing players. Game designers use audio cues to convey information to players. Players that do not accurately understand video game audio cues are disadvantages, have reduced game-play performance and are more likely to have negative game-play experiences due to their inability to determine the best input response. Video game audio cues have become even more important as games have become more advanced with increased realism. The pursuit of video game realism has led game designers to add further audio cue detail and has thereby created a greater need for audio accessibility.

Conventional systems that provide audio accessibility to deaf and hard of hearing players are either sense of touch-based haptic feedback vibrating equipment, or in-game visual cues that represent video game audio cues.

Sense of touch-based haptic feedback vibrating systems are deficient in providing video game audio cues primarily because players must be in constant contact with the vibrating equipment to be able to feel video game cues. Therefore, vibrating equipment must be either worn, held, or touched by the player. Due to this, equipment required to provide touch-based solutions may also be bulky because they require moving mechanical parts. Additionally, the requirement for moving parts leads to the inevitable mechanical failure of these systems.

In-game visual cues are deficient because they provide inconsistent sensory feedback which is dependent upon individual video game companies programming these cues into every video game release. Moreover, even if in-game visual cues are actually programmed into games, they may take on a multitude of diverse forms such as subtitles, directional arrows, flashing colors, or flashing lights. The inconsistent form of sensory feedback results in unpredictable gameplay for deaf and hard of hearing players. Additionally, the in-game visual cues need to be programmed individually for each video game and is an overhead.

Accordingly, there is a desire to solve these and other related technical problems.

### SUMMARY

In accordance with methods and systems consistent with the present invention, a method in a data processing system for providing visual display of audio signals in a video game is provided, comprising receiving an audio signal associated with the video game displayed on a display. The method further comprises converting the audio signal into a corresponding visual signal to be displayed on a light display device separate from the display and displaying, by the light display device, the corresponding visual signal.

In another embodiment, a method in a data processing system for providing visual display of audio signals in a video game is provided, comprising receiving, by an audio processing system, a stereo audio signal associated with the video game displayed on display, and splitting, by the audio processing system, the received stereo audio signal into a left audio signal and a right audio signal. The method further comprises analyzing, by the audio processing system, the left audio signal and the right audio signal, and converting, by the audio processing system, the left audio signal into a left visual cue and the right audio signal into a right visual cue based on a content of the left audio channel and the right audio channel. The method also comprises displaying the left visual cue and right visual cue to a user during gameplay of the video game on lights separate from the display.

In yet another embodiment, an audio processing system configured to display visual cues associated with audio signals in a video game is provided, comprising a memory communicatively coupled to the processor, wherein the memory stores executable instructions, which, on execution, causes the processor to receive an audio signal associated with the video game on a display. The instructions further cause the prosecutor to convert the audio signal into a corresponding visual signal to be displayed on a light display device separate from the display, and display, by the light display device, the corresponding converted visual signal. The processor is further configured to execute the instructions.

### BRIEF DESCRIPTION OF THE DRAWINGS

Other objects and features of the present system will become apparent from the following detailed description considered in connection with the accompanying drawings which disclose several embodiments of the present system. It should be understood, however, that the drawings are designed for the purpose of illustration only and not as a definition of the limits of the system.

FIG. 1 shows the front view of the audio processing system's light displays when used with large displays.

FIG. 2 shows an overview of the audio processing system.

FIG. 3 illustrates an exemplary audio processing system 200 for converting audio signal into visual cues.

FIG. 4 represents a flowchart of exemplary steps in a method for processing audio signals as visual cues in videogames.

FIG. 5 shows an exemplary front view of the audio processing system when used with mobile tablet displays.

FIG. 6 shows an exemplary front view of the audio processing system when used with mobile cell phone displays.

FIG. 7 shows an exemplary rear view of the audio processing system when used with large displays.

FIG. 8 shows an exemplary rear view of the audio processing system when used with mobile tablet displays.

FIG. 9 shows an exemplary rear view of the audio processing system when used with mobile cell phone displays.

FIG. 10 shows an exemplary prototype of the audio processing system.

FIG. 11 shows an audio processing system with game sound displayed on the right LED.

FIG. 12 shows an audio processing system with game sound displayed on the left LED.

FIG. 13 shows an audio processing system with no game sound displayed on either LED.

FIG. 14 shows an audio processing system with game sound displayed on both left and right LED's.

FIG. 15 is a flowchart that illustrates an exemplary method for displaying visual cues associated with audio content in video games by the audio processing system.

### DETAILED DESCRIPTION

Methods and systems in accordance with the present invention provide visual display of audio signals in a video game. In one implementation, the system provides video game audio cues to deaf and hard of hearing players with audio cue reactive light emitting diode (LED) displays. These may be in the form of two lighting components placed on either side of a visual display. Audio cue reactive LED displays increase audio accessibility by converting audio stimuli into visual stimuli. Audio cue reactive LED displays can be attached to the left side and right side of any video game display, for example, to provide consistent sensory feedback that does not have to be in constant physical contact with deaf and hard of hearing players.

The lack of moving parts within the audio cue reactive LED displays enables a reduction in the bulkiness of equipment required for deaf and hard of hearing players. The probability of mechanical failure is reduced by eliminating moving parts and results in greater longevity when compared to sense of touch-based systems.

Additionally, audio cue reactive LED displays can be used with any size or shape of video game display, which results in consistent sensory feedback and more predictable gameplay for deaf and hard of hearing players. Audio cue reactive LED displays may be added to any type of display such as flat screen televisions, projected displays, computer monitors, and mobile devices to include cellphones or tablets. Ultimately, audio cue reactive LED displays resolve the deficiencies of conventional systems that provide sound stimulus for deaf and hard of hearing by providing visual video game cues that are consistent across all video games and displays.

The audio processing system provides a device for converting audio cues into visual cues. The audio processing system converts stereo left and right channel audio signals into visual left and right LED signals. When there is a sound in the video game on the left side, the left LED flashes lights. When there is a sound in the game on the right side, the right LED flashes similarly. The magnitude of this light may be larger for a louder sound. The frequency of the sound or types of the sound may determine the colors displayed. Although described as LED's, it should be noted that any other type of suitable light may also be used.

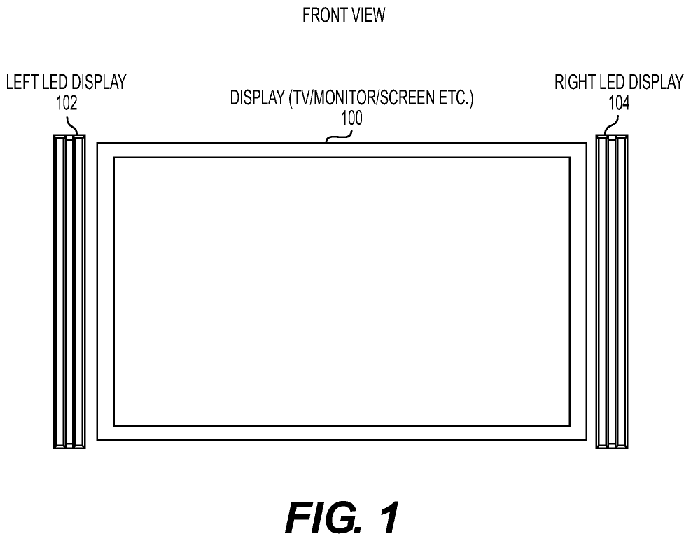

FIG. 1 shows an exemplary front view of the audio processing system's light displays when used with large displays. FIG. 1 illustrates an example of the front view for large displays 100 when connected to components of the audio processing system. For example, the system's left LED light display 102 (i.e., first display panel), and the system's right LED light display 104 (i.e., second display panel), are positioned on either side of the game display 100 (i.e., display device). Game display 100 may take the form of any display such as screen, projection, television, or computer monitor.

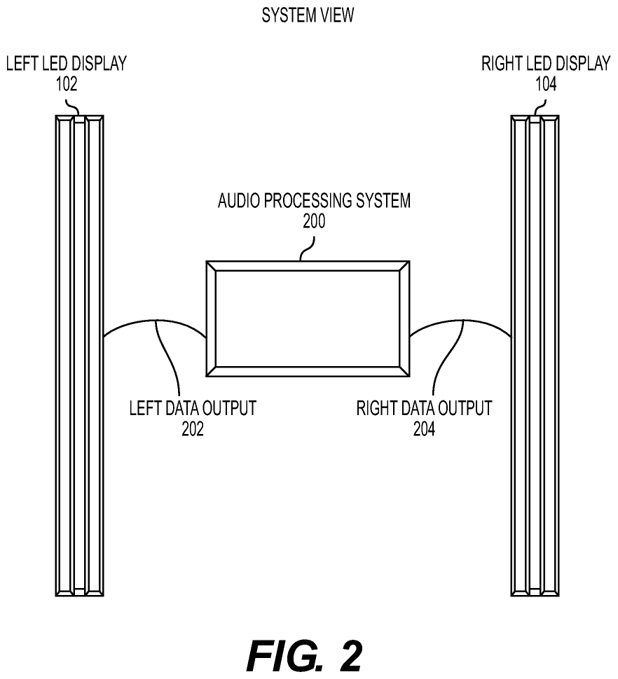

FIG. 2 shows an overview of the audio processing system 200, which includes audio capture cards and signal processing computers or processors (not shown). The audio processing system 200 may be connected to two light displays, such as left LED light display 102 and right LED light display 104 via left data output 202 and right data output 204 respectively.

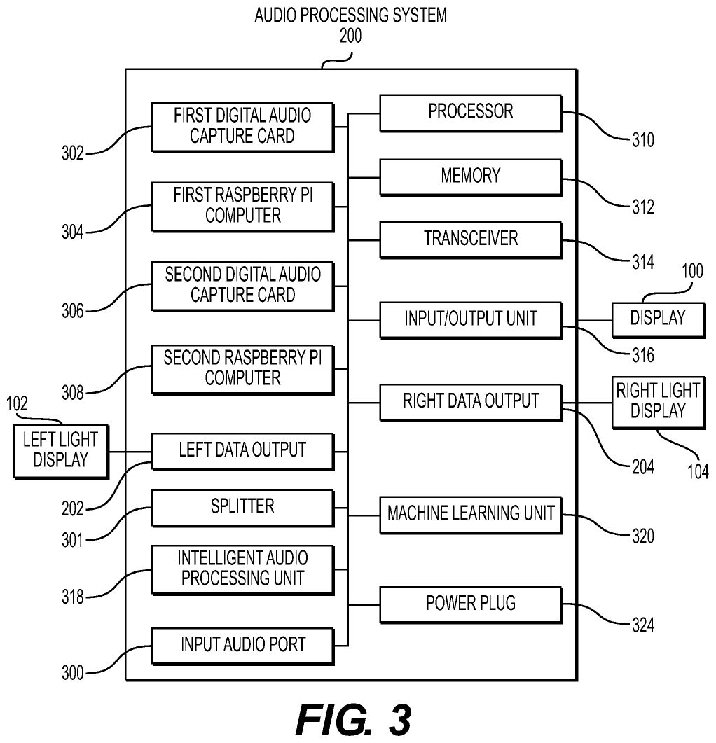

FIG. 3 illustrates an exemplary audio processing system 200 for converting audio signal into visual cues. The description of the exemplary system will be described in conjunction with the flowchart of exemplary steps.

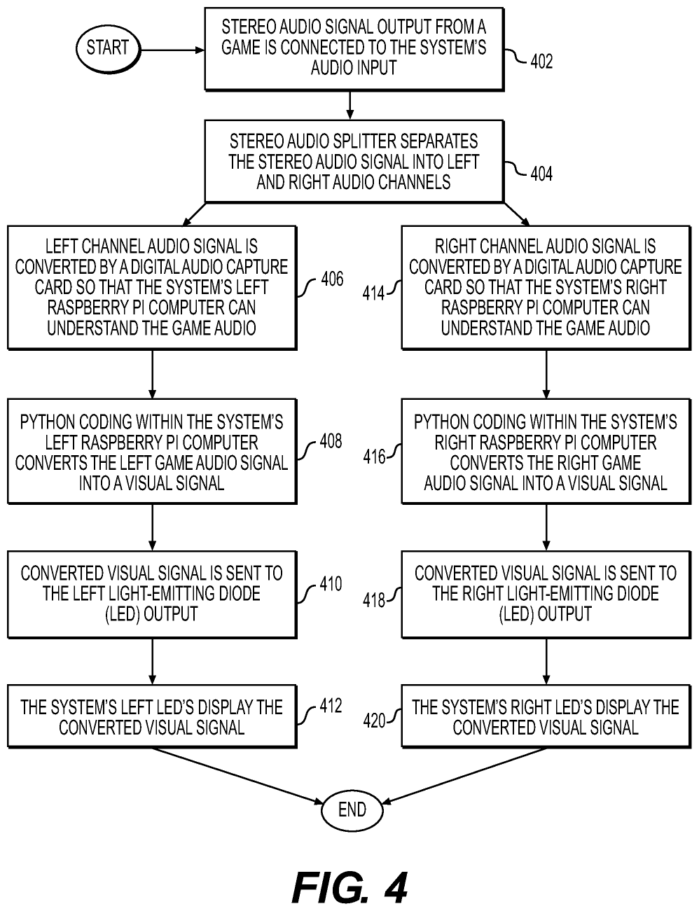

FIG. 4 represents a flowchart of exemplary steps in a method for processing audio signals as visual cues in videogames. The videogame system or display's stereo audio signal is connected to the audio processing system's audio input 300 (step 402). Then, the signal conversion process starts with receiving the stereo audio signal associated with the video game. Further, the audio processing system 100 splits the received stereo audio signal into a left audio channel and a right audio channel with a splitter 301 (step 404). The left audio channel is converted by a first digital audio capture card 302 so that the audio processing system's left Raspberry Pi 3 B+ computer 304 can understand the left audio channel video game audio (step 406). In an alternate embodiment, any other suitable computer, computing device or processor may be used. In one implementation, the audio capture cards may be DIGITNOW USB audio capture cards. Further, Python program language coding within the audio processing system's left Raspberry Pi 3 B+ computer 302 converts the left audio channel into a left visual cue (step 408). Any other suitable programming language or software may be used. Further, the converted left visual cue is sent to the left light display 102 containing LED's (step 410). Thus, the audio processing system's left LED's 102 display the converted left visual signal (step 412).

The signal conversion process occurs simultaneously on the right side of the system. The right audio channel is converted by a second digital audio capture card 306 so that the audio processing system's right Raspberry Pi 3 B+ computer 308 can understand the right audio channel in the video game (step 414). Further, the Python coding within the audio processing system's Raspberry Pi 3 B+ computer 308 converts the right audio channel into a right visual cue (step 416). Further, Further, the converted right visual cue is sent to the right light display 104 containing LED's (step 418). Thus, the audio processing system's right LED's 104 display the converted right visual signal (step 420).

Here, the first digital audio capture card 302 and the second digital audio capture card 306 and the Raspberry Pi computers 304 and 308 act as signal converting processors that convert the stereo audio signal from the game into visual signals. These then transmit the visual signal for the left audio channel through the left data output, and transmit the visual signal for the right audio channel through the data output. The visual signal data (left visual cue) converted from the left audio channel enters the left LED display 102 at the same time as the visual signal data (right visual cue) converted from the right audio channel enters the right LED display 104.

In one implementation, to convert the audio signal, the audio processing system's python code takes the digital signal from the audio converter and uses Pyaudio to further transform the digital audio signal into a data array using the NumPy python library. The python code then samples the converted NumPy array data and assigns the data to associated hertz frequencies based upon the Mel frequency scale of sound. The assigned hertz frequencies are then displayed in Red Green and Blue (RGB) LED colors. The number of RGB color LED pixels that are lit depends upon the decibel level of the converted digital signal. The higher the decibel level, the more numerous the lit LED pixels will be.

In one implementation, the audio processing system 200 may be configured to convert the left audio channel and the right audio channel into text using one or more machine learning techniques and further displaying sounds as text on the display device during gameplay. For example, during gameplay gunshots may be fired from the right and the audio processing system may display text such as “Gunshots!!!” on the right side of the display screen. The one or more machine learning techniques may translate context information identified by analyzing each of the left audio channel and the right audio channel and then may display text on either the left of right side of the screen during gameplay.

In another implementation, instead of a video gameplay audio, the system may also provide visual cues associated with any sound generated by an electronic device, such as a laptop, desktop, table or mobile device. For example, when an email is received on a personal laptop then the notification sound of the received email may be displayed as a visual cue a single light, a left light display 102 and right light display 104 or any other suitable arrangement. In another embodiment, any kind of sound generated by an electronic device for example, an incoming phone call, alert messages, alarms, reminders, notification may be displayed as a visual cue using the plurality of left LED's 102 and the plurality of right LED's 104.

Referring further to FIG. 3, an overview of additional components of the audio processing system 200 is provided. The audio processing system 200 further comprises a processor 310, a memory 104, a transceiver 314, input/output unit 316. The audio processing system 200 further comprises an intelligent audio processing unit 318, and a machine learning unit 320. It is noted that, in one implementation, the system may be run with one or more processors without Raspberry Pi computers.

The plurality of left LED's are fixed in an enclosed first compartment that represents a first display panel 102. The plurality of right LED's are fixed in an enclosed second compartment that represents a second display panel 104.

In an embodiment, the first display panel 102 and the second display panel 104 that display the visual cues are attached to a left side and right side of a display device 100, respectively using one or more clamps, or a clamping mechanism. The audio processing system 200 further comprises an input audio port 300. In an embodiment, the input audio port 300 is a standard 3.5 mm headphone jack. In an alternate embodiment, the input audio port 300 is a standard HDMI input jack. The audio processing system 200 further comprises a power plug 324 that provides electrical power to the audio processing system 200.

The processor 310 may be communicatively coupled to the memory 312, the transceiver 314, the input/output unit 316, the first digital audio capture card 110, the second digital audio capture card 112, the first Raspberry Pi computer 304, the second Raspberry Pi computer 308, the splitter 301, the intelligent audio processing unit 318, and the machine learning unit 320. The processor 310 may work in conjunction with the aforementioned units for providing visual display of audio signals in a video game. In an embodiment, the transceiver 314 may be communicatively coupled to a communication network.

The processor 310 comprises suitable logic, circuitry, interfaces, and/or code that may be configured to execute a set of instructions stored in the memory 312. The processor 310 may work in conjunction with the aforementioned units for providing visual display of audio signals in a video game. Examples of the processor 310 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 312 comprises suitable logic, circuitry, interfaces, and/or code that may be configured to store the set of instructions, which are executed by the processor 310. In an embodiment, the memory 312 may be configured to store one or more programs, routines, or scripts that are executed in coordination with the processor 310. The memory 312 may be implemented based on a Random Access Memory (RAM), flash drive, a Read-Only Memory (ROM), a Hard Disk Drive (HDD), a storage server, and/or a Secure Digital (SD) card.

The transceiver 314 comprises of suitable logic, circuitry, interfaces, and/or code that may be configured to receive a stereo audio signal associated with the video game, via the communication network or via an input audio port. The transceiver 314 may be further configured to transmit the left visual cue and the right visual cue to the plurality of left LED's 102 and a plurality of right LED's 104, respectively. The transceiver 314 may implement one or more known technologies to support wired or wireless communication with the communication network 106. In an embodiment, the transceiver 314 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 314 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output unit 316 comprises suitable logic, circuitry, interfaces, and/or code that may be configured to provide one or more inputs to the audio processing system during gameplay of the video game. The input/output unit 316 comprises of various input and output devices that are configured to communicate with the processor 310. Examples of the input devices include, but are not limited to, a keyboard, a mouse, a joystick, a touch screen, a microphone, a camera, and/or a docking station. Examples of the output devices include, but are not limited to, a microphone, a display screen and/or a speaker.

The first digital audio capture card 110 may correspond to a USB 2.0 Audio Capture Card Device that provides users an easy solution to digitize analogue audio signals into a digital format via an USB interface. The first digital audio capture card 110 contains a built-in phono pre-amp and connects to an electronic device, such as a personal computer, laptop and the like through a USB port. The first Raspberry Pi computer 304 may be configured to determine context information associated with the left audio channel of the video game.

The second digital audio capture card 112 may correspond to a USB 2.0 Audio Capture Card Device that provides users an easy solution to digitize analogue audio signals into a digital format via an USB interface. The second digital audio capture card 112 contains a built-in phono pre-amp and connects to an electronic device, such as a personal computer, laptop and the like through a USB port. The second Raspberry Pi computer 308 may be configured to determine context information associated with the right audio channel of the video game.

The splitter 301 may comprise suitable logic, circuitry, interfaces, and/or code that may be configured to split the received stereo audio signal into the left audio channel and the right audio channel. The splitter 301 may be, for example, a 6 inch Y Cable, 3.5 mm ⅛″ TRS Male to 2×3.5 mm Female Cord from Keen Eye, Inc.

The intelligent audio processing unit 318 that comprises suitable logic, circuitry, interfaces, and/or code that may be configured to work in conjunction with the first Raspberry Pi computer 304 and the second Raspberry Pi computer 308 to analyze each of the left audio channel and the right audio channel to determine context information associated with the video game. The intelligent audio processing unit 318 may be configured to convert the left audio channel into a left visual cue and the right audio channel into a right visual cue based on the determined context.

The machine learning unit 320 that comprises suitable logic, circuitry, interfaces, and/or code that may be configured to convert the left audio channel and the right audio channel into text using one or more machine learning techniques. The one or more machine learning techniques may translate context information identified by analyzing each of the left audio channel and the right audio channel and then may display text on either the left of right side of the screen during gameplay. In an embodiment, the machine learning unit 320 may be configured to automatically configure one or more game audio settings associated with the video game.

The display device 100 may correspond to TV, computer monitor, a mobile phone screen, a tablet screen and the like that may be configured to display the gameplay of the user.

In operation, the audio processing system 200 is turned on using the input power plug, and receives the stereo audio signal associated with the video game. In an alternate embodiment, the transceiver 314 may be configured to receive the stereo audio signal associated with the video game, via the communication network or via the input audio port. In an embodiment, the input audio port is a standard 3.5 mm headphone jack. Further, the input audio port and the display device 100 are connected via an audio cable. In an embodiment, the stereo audio signal that is playback during the gameplay comprises at least one of: speaking, game music, explosions, background sound, footsteps, gunfire, water rattling, wind sounds, and vehicle sounds.

After receiving the stereo audio signal, the splitter 301 may be configured to split the received stereo audio signal into the left audio channel and the right audio channel. After splitting, the intelligent audio processing unit 318 in conjunction with the first Raspberry Pi computer 304 and the second Raspberry Pi computer 308 may analyze each of the left audio channel and the right audio channel to determine context information associated with the video game. In an embodiment, the determined context information comprises one of footsteps, weapons loot boxes, approaching enemy vehicles, gunfire, and explosions that occur during gameplay within the video game.

Further, the intelligent audio processing unit 318 may be configured to convert the left audio channel into the left visual cue and the right audio channel into the right visual cue based on the determined context. Once the context is determined then the machine learning unit 320 may dynamically configure one or more game audio settings associated with the video game. In an embodiment, the machine learning unit 320 may dynamically turn off background sound during gameplay of the video game. Further, in an embodiment, the machine learning unit 320 may turn off game voice chat settings during gameplay of the video game. Similar to the above, the machine learning unit 320 may toggle or change one or more game audio settings associated with the video game based on the determined context information.

After the conversion, the input/output unit 316 may be configured to display the left visual cue and the right visual cue to a user during gameplay of the video game. In an embodiment, the in-game left visual cues and right visual cues are displayed across multiple gaming platforms irrespective of the display device properties and size of the display device.

The plurality of left LED's 102 and the plurality of right LED's 104 have multiple colors, and each color may represent different types of sounds. Generally, the colors are primarily based upon the frequency of the sound while the size and/or brightness of the LED light displayed is based upon the decibel level. In one implementation, increased size or brightness of the light may be accomplished by lighting up more of the LED's in the light display.

For example, blue and green may be generally lower frequency sounds like vehicles or footsteps, while reds and oranges may be generally higher frequency sounds like gunshots or nearby explosions. In one implementation, the LED color may be more red or orange the louder (or closer) the sound is. In one implementation, red indicates very loud or nearby sounds. The LED color for footsteps may also change based upon the type of ground that the enemy is walking on. Footsteps on metal, or hard ground may show up red. Footsteps on grass, sand, or water may show up blue.

One implementation illustrating a potential exception is loud nearby sounds tend to show up red or orange or white, and quiet sounds tend to show up blue or green even if they are generally high frequency sounds such as gunshots. In an embodiment, the color of the LED's is more red or orange based on distance of origination of the sound within the video game. For example, if the footsteps sound of another opponent user is coming from very close proximity of the user, then such footsteps sounds may be displayed in orange color. Paying more attention to LED light size at first may be a good indicator for a user.

In an embodiment, the color of the left LED light display 102 and the right LED light display 104 changes based upon the frequency, while the size, brightness or number of LED's displayed is based on loudness, i.e., decibel level of the left audio channel and right audio channel. For example, the stereo audio signal is processed by python code to analyze the frequency and decibel levels, and lower frequencies (bass) are displayed via LED as blues and greens, and higher frequencies (treble) are displayed as reds and oranges.

In an embodiment, the color of the LED's is more red or orange based on distance of origination of the sound within the video game. For example, if the footsteps sound of another opponent user is coming from very close proximity of the user, then such footsteps sounds may be displayed in orange color.

In an embodiment, the machine learning unit 320 may be configured to adjust brightness of the left LED light display 102 and the right LED light display 104 by increasing or decreasing the volume of the display device 100 based on ambient lighting in the room where the user is playing the video game.

A person skilled in the art will understand that the scope of the disclosure should not be limited to providing visual display of audio signals in a video game based on the aforementioned factors and using the aforementioned techniques. Further, the examples provided are for illustrative purposes and should not be construed to limit the scope of the disclosure.

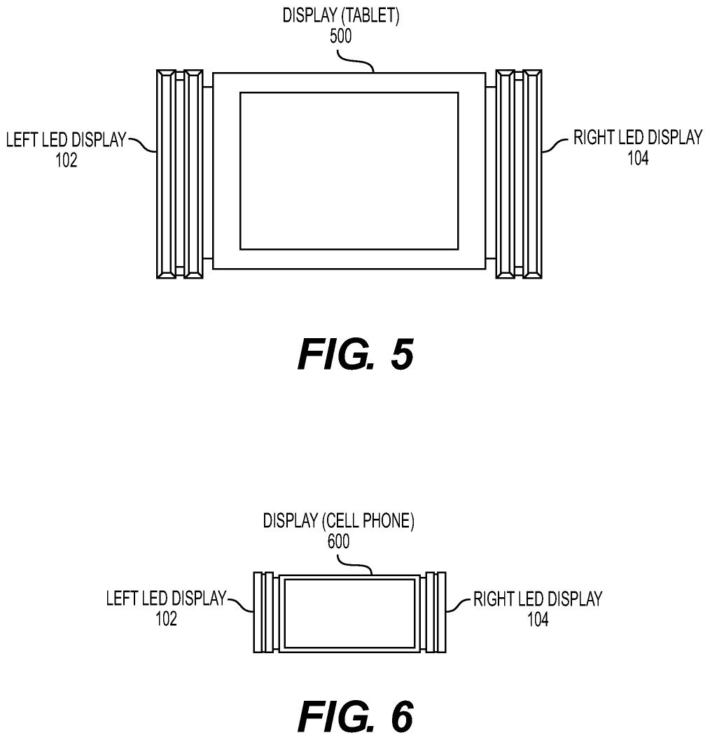

FIG. 5 shows an exemplary front view of the audio processing system 200 when used with mobile tablet displays. FIG. 3 illustrates an example of the front view for mobile tablet displays when connected to components of the audio processing system 200. For example, the system's left LED light display 102, and the system's right LED light display 104 are positioned on either side of the mobile tablet game display 500 (i.e., display device). Game display 500 may take the form of any mobile tablet display.

FIG. 6 shows an exemplary front view of the audio processing system 200 when used with mobile cell phone displays. FIG. 6 illustrates an example of the front view for mobile cell phone displays when connected to components of the audio processing system 200. For example, the system's left LED light display 102, and the system's right LED light display 104 are positioned on either side of the mobile cell phone game display 600 (i.e., display device). Game display 600 may take the form of any mobile cell phone display.

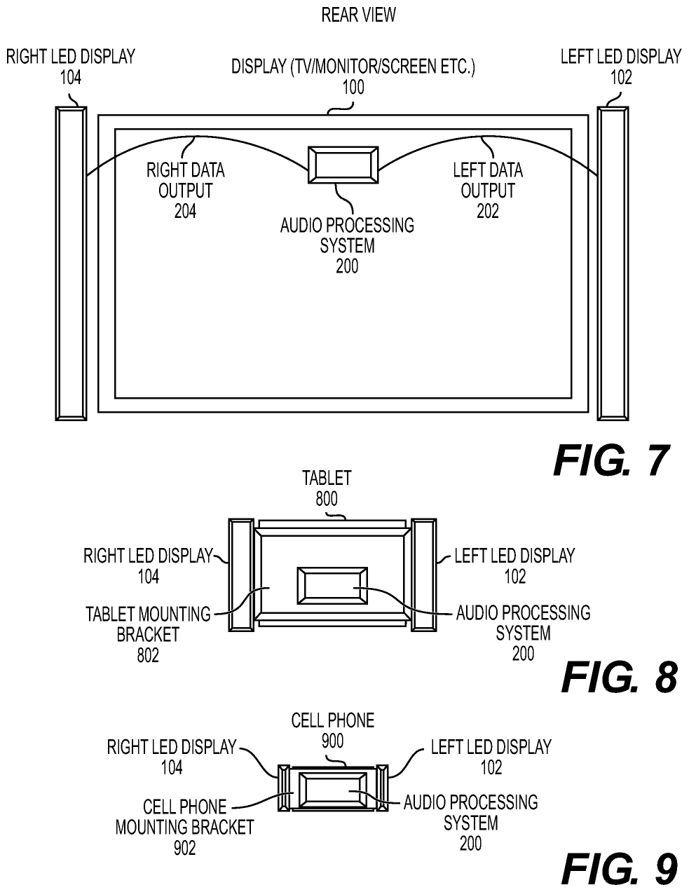

FIG. 7 shows an overview of the rear view of the audio processing system 200 when used with large displays. FIG. 7 illustrates an example of the rear view for the components of the audio processing system 200 when connected to a large display. For example, the system's left LED light display 102, and the system's right LED light display 104 are positioned on either side of the game display 100 (i.e., display device). Game display 100 may take the form of any display such as screen, projection, television, or computer monitor. In an embodiment, the audio processing system 200 converts the audio signal output from the game into visual signals. It then transmits the visual signal for the left audio channel through data output 202, and transmits the visual signal for the right audio channel through data output 204 simultaneously.

FIG. 8 shows an overview of the rear view of the audio processing system 200 when used with mobile tablet displays. FIG. 8 illustrates an example of the rear view for the components of the audio processing system 200 when connected to a mobile tablet. For example, the system's left LED light display 102, and the system's right LED light display 104 are positioned on either side of the mobile tablet 800. The audio processing system 200 converts the stereo audio signal output from the game into visual signals. The audio processing system 200 then transmits the visual signal for the left audio channel to left LED display 102, and transmits the visual signal for the right audio channel to right LED display 104 simultaneously. Tablet mounting bracket 802 (clamping mechanism) holds the components of the system together and acts as a rear surface protector for the mobile tablet 800.

FIG. 9 shows an overview of the rear view of the audio processing system 200 when used with mobile cell phone displays. FIG. 9 illustrates an example of the rear view for the components of the audio processing system 200 when connected to a mobile cell phone. For example, the system's left LED light display 102, and the system's right LED light display 104 are positioned on either side of the mobile cell phone. Mounting bracket 902 (clamping mechanism) holds the components of the system together and acts as a rear surface protector for the mobile cell phone. Further, the audio processing system 200 converts the stereo audio signal output from the game into visual cues.

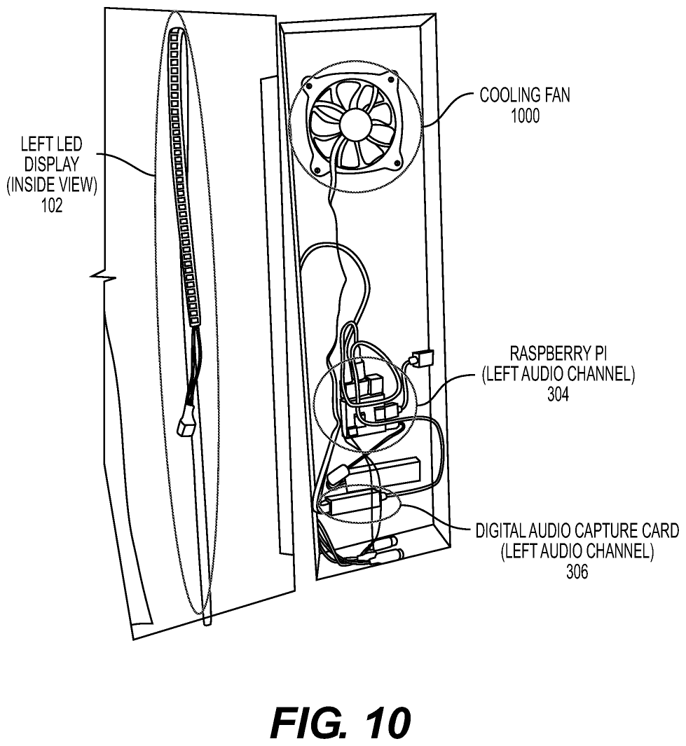

FIG. 10 shows an overview of an exemplary prototype of an audio processing system 200. This figure illustrates the left audio channel system components in an illustrated photo. For example, the inside of the system's left LED light display 102 indicates where LED lights flash when there is a game sound on the left. The left Raspberry Pi 3B+ 304 contains the coding required to convert the left game audio signal (i.e., left audio channel) into a visual cue for the left LED 102. The left digital audio capture card 306 converts the left audio input signal so that the system's Raspberry Pi 3 B+ computer 304 can understand the left channel game audio. The left cooling fan 1000 circulates air so that the system does not overheat.

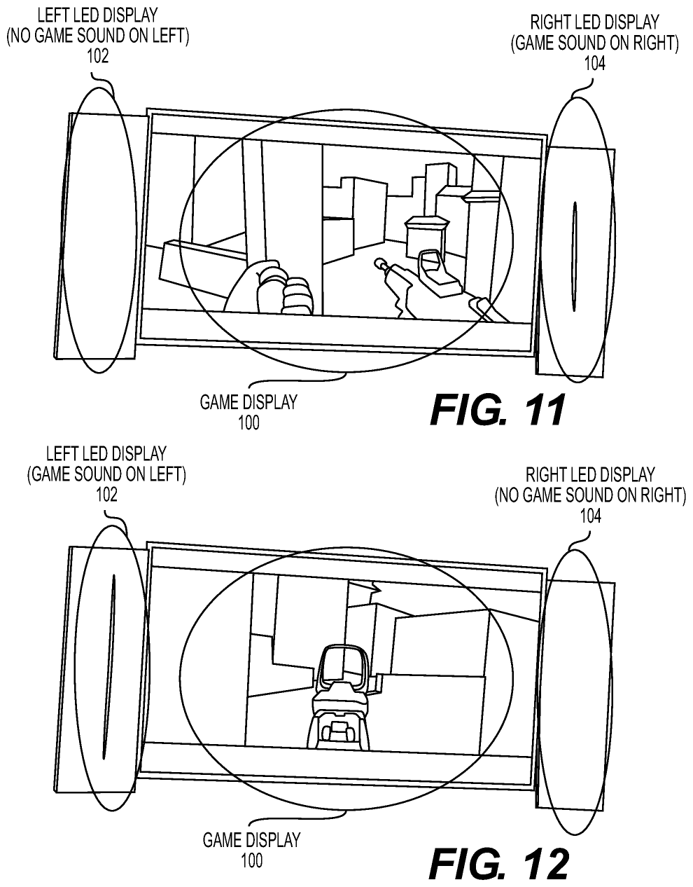

FIG. 11 shows an overview of a prototype of the audio processing system 200 with game sound displayed on the right LED. FIG. 11 describes the audio processing system 200 as it displays right game audio cues as visual cue LED lights on the right. For example, the left LED display 102, is blank because there is no game sound on the left. The right LED display 104, is displaying LED lights because there is game sound on the right. The game display 100, shows a first person view of the game being played.

FIG. 12 shows an overview of a prototype of the audio processing system 200 with game sound displayed on the left LED 102. FIG. 12 describes the audio processing system 200 as it displays game audio cues as visual cue LED lights on the left. For example, the left LED display 102, is displaying LED lights because there is game sound on the left. The right LED light display 104 is blank because there is no game sound on the right. The game display 100, shows a first person view of the game being played.

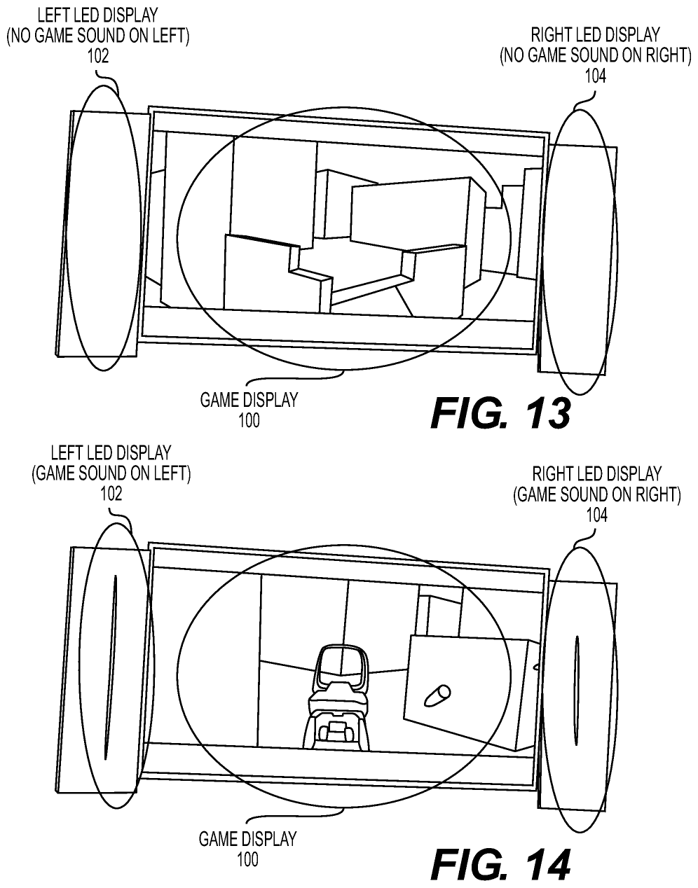

FIG. 13 shows an overview of a prototype of the audio processing system with no game sound displayed on either LED. FIG. 13 describes the system as it displays no game audio cues on the visual cue LED lights on the left or right. For example, the left LED light display 102, is blank because there is no game sound on the left. The right LED light display 104, is blank because there is no game sound on the right. Both left and right LED displays 102 and 104 are blank because there are no game audio cues during this portion of the game. The game display 100 shows a first-person view of the game being played.

FIG. 14 shows an overview of a prototype of the audio processing system 200 with game sound displayed on both left and right LED's. FIG. 14 describes the audio processing system 200 as it displays game audio cues on the visual cue LED lights on both the left and right. For example, the left LED display 102 is displaying LED lights because there is game sound on the left. The right LED light display 104 is displaying LED lights because there is game sound on the right. Both left and right LED displays 102 and 104 are displaying lights because there are game audio cues on both the right and left during this portion of the game. The game display 100, shows a first person view of the game being played.

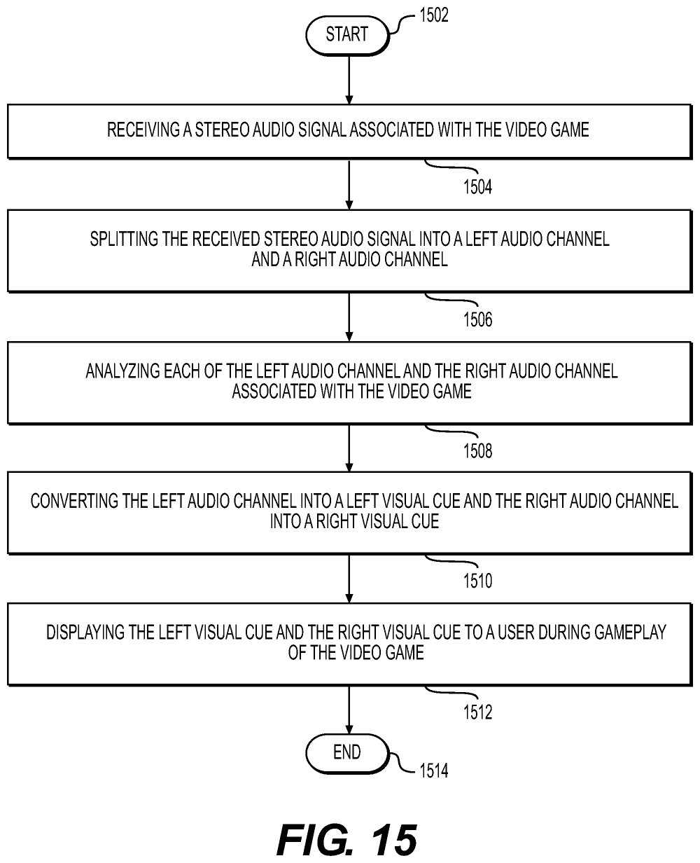

FIG. 15 is a flowchart that illustrates a method for displaying visual cues associated with audio content in video games by the audio processing system, in accordance with one embodiment.

At step 1504, the audio processing system may be configured to receive a stereo audio signal associated with the video game. At step 1506, the audio processing system may be configured to split the received stereo audio signal into a left audio channel and a right audio channel. At step 1508, the audio processing system may be configured to analyze each of the left audio channel and the right audio channel to determine context information associated with the video game. At step 1510, the audio processing system may be configured to convert the left audio channel into a left visual cue and the right audio channel into a right visual cue based on the determined context. At step 1512, the audio processing system may be configured to display the left visual cue and right visual cue to a user during gameplay of the video game. Control passes to end step 1514.

The system has been engineered for deaf and hard of hearing gamers, however all gamers can benefit from the visual display of sound direction. The system can be used for computer gaming, console gaming, and mobile tablet or cell-phone gaming. Ultimately, the system solves the deficiencies of other inefficient audio cue conversion systems by providing visual video game cues that are consistent across all video games and displays and also across multiple gaming platforms.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for providing visual display of audio signals in a video game, comprising:
receiving an audio signal associated with the video game displayed on a display;
converting the audio signal into a corresponding visual signal to be displayed on a light display device separate from the display; and
displaying, by the light display device, the corresponding visual signal.

2. The method of claim 1, wherein the displaying further comprises:
displaying the visual signal on the light display device based on a magnitude of the audio signal.

3. The method of claim 2, wherein a brightness of the visual signal is based on the magnitude of the audio signal.

4. The method of claim 1, further comprising:
displaying the visual signal on the light display device based on a frequency of the audio signal.

5. The method of claim 4, wherein a color of the visual signal is based on the frequency of the audio signal.

6. The method of claim 1, further comprising:
splitting the audio signal into a left audio and right audio signal;
analyzing the left audio signal and the right audio signal;
converting the left audio signal into a left video signal and the right audio signal into a right video signal;
transmitting the converted left video signal to a left light display and the right video signal to a right light display; and
displaying the left video signal on the left light display and the right video signal on the right light display.

7. The method of claim 6, further comprising:
displaying a color of the light display based on a frequency of the left audio signal and a color of the right light display based on a frequency of the right audio signal.

8. The method of claim 7, further comprising;
displaying a size of a light on the left light display based on a magnitude of the left audio signal and a size of a light on the right light display based on a magnitude of the right audio signal.

9. A method in a data processing system for providing visual display of audio signals in a video game, the method comprising:
receiving, by an audio processing system, a stereo audio signal associated with the video game displayed on display;
splitting, by the audio processing system, the received stereo audio signal into a left audio signal and a right audio signal;
analyzing, by the audio processing system, the left audio signal and the right audio signal;
converting, by the audio processing system, the left audio signal into a left visual cue and the right audio signal into a right visual cue based on a content of the left audio channel and the right audio channel; and
displaying the left visual cue and right visual cue to a user during gameplay of the video game on lights separate from the display.

10. The method of claim 9, further comprising:
displaying the color of the light based on the frequency of the left and right audio signal, and a size of a light on the lights based on the magnitude of the left audio signal and the right audio signal.

11. The method of claim 9, wherein a blue color and a green color represent sounds that correspond to vehicle sounds or footsteps in the video game, and wherein a red color and an orange color represent sounds that correspond to gunshots or explosions in the video game.

12. An audio processing system to provide visual display of audio signals in a video game, comprising:
a memory communicatively coupled to a processor, wherein the memory stores executable instructions, which, on execution, causes the processor to:
receive an audio signal associated with the video game on a display;
convert the audio signal into a corresponding visual signal to be displayed on a light display device separate from the display; and
display, by the light display device, the corresponding converted visual signal; and
the processor configured to execute the instructions.

13. The audio processing system of claim 12, wherein the audio processing system further comprises:
the light display device configured to display the converted visual signal.

14. The audio processing system of claim 13, wherein the light display device comprises:
a left light display and a right light display.

15. The audio processing system of claim 12, wherein the displaying further comprises:
displaying the visual signal on the light display device based on a magnitude of the audio signal.

16. The audio processing system of claim 15, wherein a brightness of the visual signal is based on the magnitude of the audio signal.

17. The audio processing system of claim 12, further comprising:
displaying the visual signals on the light display device based on a frequency of the audio signal.

18. The audio processing system of claim 17, wherein a color of the visual signals is based on the frequency of the audio signals.

19. The audio processing system of claim 14, wherein the processor is further configured to:
split the audio signal into a left audio and right audio signal;
analyze the left audio signal and the right audio signal;
convert the left audio signal and the right audio signal into a left video signal and a right video signal;
transmit the converted left video signal to the left light display and the right video signal to the right light display; and
display the left video signal on the left light display and the right video signal on the right light display.

20. The audio processing system of claim 19, wherein the processor is further configured to:
display a color of the light display based on a frequency of the left audio signal and a color of the right light display based on a frequency of the right audio signal; and
display a size of a light on the left light display based on a magnitude of the left audio signal and size of a light on the right light display based on a magnitude of the right audio signal.
